(19) United States
(12) Patent Application Publication
(10) Pub. No.: US 2022/0381627 A1
(43) Pub. Date: Dec. 1, 2022

(54) FREEZING DETECTION DEVICE

(71) Applicant: EGG CO,. Ltd., Busan (KR)

(72) Inventor: Young Beum KIM, Busan (KR)

(21) Appl. No.: 17/771,579

(22) PCT Filed: Nov. 3, 2020
(86) PCT No.: PCT/KR2020/015189

§ 371 Date: Apr. 25, 2022

(30) Foreign Application Priority Data
Nov. 15, 2019 (KR) 10-2019-0146612

(51) Int. Cl. G01K 13/02; G01K 13/024

(52) U.S. Cl. CPC G01K 13/028; G01K 13/024

(57) ABSTRACT

The present invention provides, in order to improve detection accuracy, a freezing detection device comprising: a strut having a mounting space formed therein, the strut being installed in a freezing measurement area in which a freezing detection object unit is disposed; a probe made of a magnetostrictive material and disposed to penetrate the strut, the lower end of the probe being inserted into the mounting space, the upper end thereof being exposed to the freezing measurement area, the probe having a drive coil disposed so as to surround the outer periphery of one side of the interior of the mounting space such that a driving magnetic field for magnetostrictive vibration is formed, and the probe having a feedback coil disposed so as to surround the outer periphery of the other side of the interior of the mounting space while being spaced apart from the drive coil by a predetermined interval; a variable adjustment unit circuit-connected to the drive coil and the feedback coil such that errors of a vibration frequency occurring in the probe are adjusted; a magnet unit disposed along outer peripheries of the drive coil and the feedback coil such that the vibration displacement of the probe increases, thereby forming a bias magnetic field; an elastic member disposed in the mounting space and provided to have an elastic modulus preconfigured such that a vibration frequency occurs in the probe, the elastic member generating magnetostrictive vibration and elastically supporting the probe; and so as to apply a voltage corresponding to a vibration frequency, the calculation control unit indirectly assessing the freezing condition of the freezing detection object unit through a change in the vibration frequency of the probe resulting from a freezing load.

### TECHNICAL FIELD

The present invention relates to an icing detection device, and more specifically, to a freezing detection device with improved detection accuracy.

### BACKGROUND ART

Generally, icing or freezing detection devices are devices which are installed at expected icing points of aircraft or vessels operating in extremely low temperature environments in order to prevent performance degradation or breakdown of the aircraft and the like due to icing.

In this case, an icing phenomenon of an aircraft occurs at a surface of the aircraft, such as an engine entrance, a wing leading edge, and a propeller, when the aircraft flies in the atmospheric environment containing moisture such as clouds at subzero temperatures. Particularly, when icing occurs at the wing leading edge, a lifting force decreases, a drag force increases, and thus flight performance and safety are adversely affected. Installation of icing detection devices with high reliability and durability are essential in order to solve such problems.

One or more icing detection devices are installed on surfaces of a wing, an engine nacelle, and the like and serve to detect whether icing occurs on the surfaces of the wing, the nacelle, and the like before ice is formed thereon and notify whether icing occurs to a pilot of an aircraft or vessel.

In addition, icing detection devices may detect icing through various methods, such as a method of directly detecting temperatures of a wing, a nacelle, and the like of an aircraft using temperature sensors, thermal imaging cameras, and the like and a method of indirectly measuring an oscillation displacement changed when icing occurs.

In this case, an oscillation type freezing detection device may include a probe for detecting icing. In this case, the probe may be provided in a cylindrical shape having a hemispherical end portion and disposed on a wing, an engine nacelle, or the like of an aircraft in a state in which the end portion protrudes therefrom, and when the probe is oscillated by an elastic unit, a frequency due to the oscillation may be measured.

In addition, whether icing is detected on a surface of a wing, an engine nacelle, or the like of an aircraft may be indirectly determined through a change in difference in oscillation frequency of a probe when icing does not occur and when icing occurs.

Specifically, in A freezing detection device to which a magnetostrictive oscillation (MSO) principle is applied, coils are wound around both ends of a probe formed of a ferromagnetic substance such as a nickel alloy, and a current is applied thereto to generate a constant resonance frequency. Using such a principle, when ice accumulates on a probe of an MSO icing detection device, a response frequency of the probe may be lower than a natural moving nominal resonance frequency (NRF), and whether icing occurs may be detected by detecting the response frequency.

In this case, a moving NRF is a natural frequency generated by the MSO probe when icing does not occur on the MSO probe of the icing detection device.

However, in a conventional icing detection device, since an NRF is not kept constant due to winding amount and interval changes, changes in magnetic forces, or the like of coils wound around two ends of a probe, there is a serious problem that icing detection accuracy is lowered.

Accordingly, there is a problem that the flight safety of an aircraft is degraded due to a serious problem that icing cannot be accurately detected by the freezing detection device provided in order to detect the icing in advance.

In addition, when an NRF of A freezing detection device is not kept constant, since a task of replacing the freezing detection device or internal circuit is required, there are problems that workability is significantly lowered, and particularly, it is difficult to perform replacement work immediately during operation.

### DISCLOSURE

### Technical Problem

The present invention is directed to providing a freezing detection device with improved detection accuracy.

### Technical Solution

One aspect of the present invention provides a freezing detection device including a strut installed in an icing measurement area in which an icing detection target is disposed and having an installation space formed therein, a probe which is formed of a magnetostrictive material and disposed to pass through the strut and has a lower end portion inserted into the installation space and an upper end portion exposed to the icing measurement area and in which a drive coil configured to generate a driving magnetic field for magnetostrictive oscillation is disposed to surround an outer circumference of one side of an interior of the installation space and a feedback coil disposed to be spaced a preset distance from the drive coil is disposed to surround an outer circumference of the other side of the interior of the installation space, a variable adjustment unit circuit-connected to the drive coil and the feedback coil to adjust an error of the oscillation frequency generated by the probe, a magnet unit disposed along an outer circumference of the drive coil and an outer circumference of the feedback coil to generate a bias magnetic field so as to increase the oscillation displacement of the probe, an elastic member which is disposed in the installation space and provided with a preset elasticity modulus to allow the probe to generate an oscillation frequency, generates a magnetostrictive oscillation, and elastically supports the probe, and a calculation control unit which is connected to the variable adjustment unit in the circuit and applies a voltage corresponding to the oscillation frequency to the variable adjustment unit, and indirectly determines an iced state of the icing detection target through a change in the oscillation frequency of the probe due to an ice load.

### Advantageous Effects

The present invention provides the following effects through above-described solutions.

First, unlike a conventional case in which a sensor device is directly installed on an icing detection target, an iced state of an icing detection target is indirectly detected through a change in oscillation frequency of a probe disposed in an icing measurement area which is similar and close to a target area. Accordingly, driving performance degradation of the icing detection target can be prevented, and the iced state can be stably monitored.

Second, a variable adjustment unit is provided as a transistor to variably adjust a voltage applied to a feedback coil, and a voltage applied to a base of the transistor is remotely controlled by a PC unit installed in a cockpit or the like. Accordingly, since a moving nominal resonance frequency which is initially set for the probe is quickly accurately adjusted, operational safety can be significantly improved.

Third, unlike the conventional case in which a moving nominal resonance frequency is adjusted through a physical operation such as winding amount and interval changes of coils, replacing a magnet unit, and the like, since a voltage applied to the variable adjustment unit circuit-connected to the feedback coil is controlled by a calculation control unit communicatively-connected to the PC unit, the moving nominal resonance frequency can be adjusted easily.

Fourth, since the PC unit automatically controls the voltage applied to the base of the transistor, the constant moving nominal resonance frequency is adjusted within a range of a preset oscillation frequency. Accordingly, reliability of sensitivity, which is calculated as a ratio of a decrease in a response frequency to a thickness of ice generated on a surface of the probe, can be significantly improved.

### DESCRIPTION OF DRAWINGS

FIG. 1 is an exemplary view illustrating an arrangement state of a freezing detection device according to one embodiment of the present invention.

FIG. 2 is a cross-sectional view illustrating the freezing detection device according to one embodiment of the present invention.

FIG. 3 is an exemplary view illustrating a control state of the freezing detection device according to one embodiment of the present invention.

FIG. 4 is a block diagram illustrating the freezing detection device according to one embodiment of the present invention.

FIG. 5 is a flowchart illustrating a method of controlling the freezing detection device according to one embodiment of the present invention.

### BEST MODE OF THE INVENTION

A best mode of the present invention will be described in more detail with reference to the accompanying drawings.

### Modes of the Invention

Hereinafter, a freezing detection device according to exemplary embodiments of the present invention will be described in more detail with reference to the accompanying drawings.

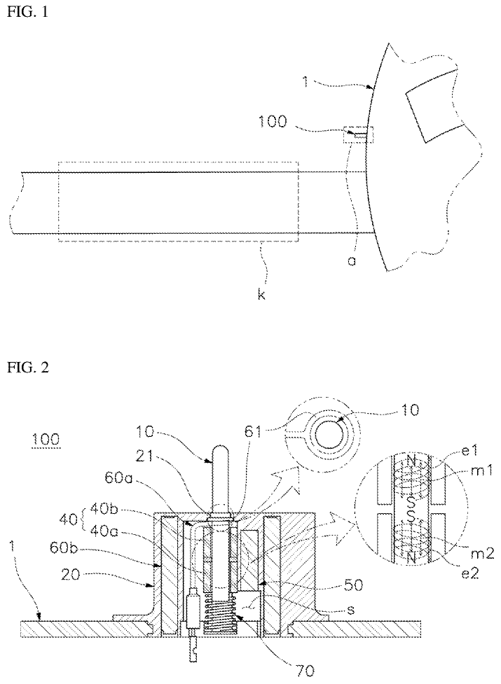

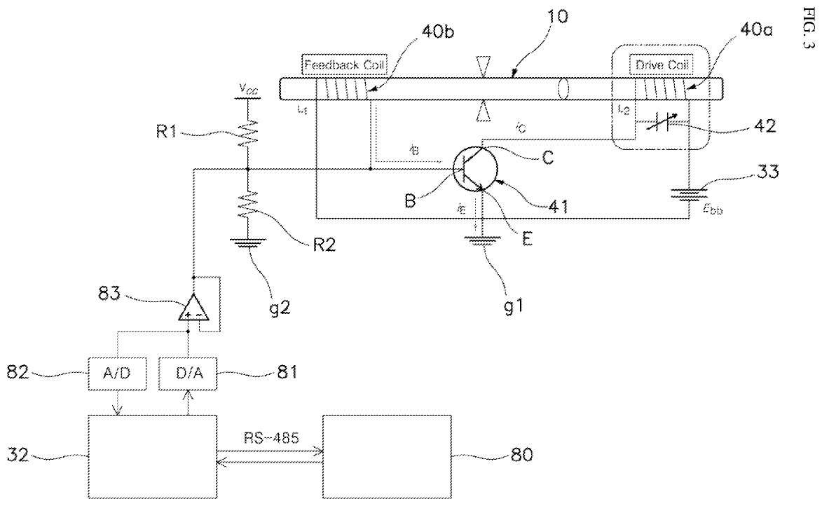

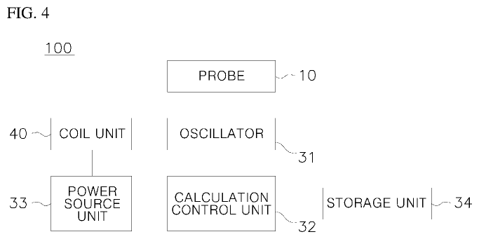

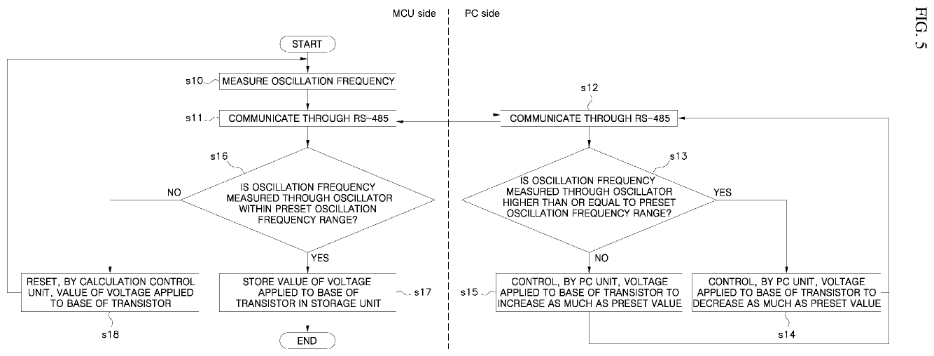

FIG. 1 is an exemplary view illustrating an arrangement state of a freezing detection device according to one embodiment of the present invention, FIG. 2 is a cross-sectional view illustrating the freezing detection device according to one embodiment of the present invention, FIG. 3 is an exemplary view illustrating a control state of the freezing detection device according to one embodiment of the present invention, FIG. 4 is a block diagram illustrating the freezing detection device according to one embodiment of the present invention, FIG. 5 is a flowchart illustrating a method of controlling the freezing detection device according to one embodiment of the present invention.

As shown in FIGS. 1 to 5, A freezing detection device 100 according to one embodiment of the present invention includes a strut 20, a probe 10, a variable adjustment unit 41, a magnet unit 50, an elastic member 70, and a calculation control unit 32.

In this case, the freezing detection device 100 is a device which detects whether icing occurs on an icing detection target 1 and a growth state thereof and transmits a monitoring signal corresponding to whether the icing occurs and the growth state thereof to a management server (not shown) and the like.

In this case, the management server (not shown) may generate a notification message for whether the icing occurs on the icing detection target 1 and the growth state thereof according to the received monitoring signal and display the notification message on a manager side display (not shown).

In this case, the notification message may be provided as a sound, an image, a text, and the like notifying whether the icing occurs on the icing detection target 1 and the growth state thereof. In addition, a series of maintenance work for removing ice generated on the icing detection target 1 may be performed according to the notification message.

In the present embodiment, an example of a fuselage of an aircraft is described as the icing detection target 1, but the icing detection target 1 is not limited thereto and may be understood as a concept that encompasses various expected icing points, such as external walls or windows of high-rise buildings, decks of ships for ice navigation, offshore structures, and blades or nacelles of wind power generators.

Meanwhile, referring to FIG. 1, the freezing detection device 100 including the strut 20 is installed in an icing measurement area a close to a target area k in which the icing detection target 1 is disposed. In this case, the icing measurement area a is an area in an environment with atmospheric conditions such as a temperature, a humidity, a wind speed, and the like which are similar to those of the target area k and may be set to an area which is close to the target area k and where it is easy to install the freezing detection device 100.

For example, when the fuselage of the aircraft is the icing detection target 1, the icing measurement area a may be set to an outer side spaced apart from the fuselage of the aircraft. In this case, the outer side of the fuselage of the aircraft is disposed close to the target area k, in which the fuselage of the aircraft is disposed, has atmospheric conditions similar to those of the target area k, is a portion in which motion such as engine rotation does not directly occur, and is easy to install the freezing detection device 100 and a wire.

In addition, since the freezing detection device 100 is not directly installed in the target area k and whether icing occurs on a surface of the aircraft and a growth state thereof according to the atmospheric conditions of the target area k are indirectly detected at the icing measurement area a close to the target area k, an influence of rotation of an aircraft engine can be minimized That is, since whether the icing occurs and the growth state thereof may be stably monitored without degradation of the performance of the icing detection target 1, product efficiency can be improved.

Meanwhile, the strut 20 may be installed in the icing measurement area a in which the icing detection target 1 is disposed, and an installation space s may be formed in the strut 20. In this case, the strut 20 may be provided as an oval column of which a cross-section has an asymmetrical oval shape of which a length of a front portion is greater than a length of a rear portion in a front-rear direction so that an airflow flowing along a side surface of strut 20 is accelerated.

Accordingly, the airflow flowing from a front side of the strut 20 to a rear side thereof may be accelerated and quickly moved when flowing along the side surface of the strut 20 provided as the asymmetrical oval column. Accordingly, since the airflow moving along the side surface of the strut 20 is accelerated, a relative atmospheric pressure of the icing measurement area a may decrease and a temperature may be decreased.

In addition, the strut 20 may be provided as the oval column of which a lower portion is open so that the installation space s is formed in the strut 20, and a probe through hole 21 for installing the probe 10 may be formed in an upper surface of the strut 20.

In addition, an expanded coupling unit, which extends outward in a radial direction, may be formed on a lower outer circumference of the strut 20 in a circumferential direction of the strut 20. In this case, the expanded coupling unit may be seated on a surface of the icing detection target 1, and a plurality of coupling holes may be formed along an outer edge of the expanded coupling unit in a vertical direction. Accordingly, since the coupling holes and the icing detection target 1 are coupled and fixed to each other in a screw-coupling manner or the like, the freezing detection device 100 may be installed on the icing detection target 1.

Furthermore, the freezing detection device 100 may further include a housing (not shown) which extends downward from an inner end of a lower portion of the strut 20 and in which various electric components including a power source unit 33 are installed. In this case, the housing (not shown) may be provided separately from the strut 20 and coupled to the strut 20, and the housing (not shown) and the strut 20 may also be integrally formed with each other.

In this case, the strut 20 may be installed at an outer side of the fuselage of the aircraft to be exposed, the housing (not shown) may be inserted into and disposed in a recessed portion formed in the icing detection target 1. In this case, the installation space s may communicate with an inner space of the housing (not shown).

In addition, the strut 20 and the housing (not shown) may be formed of a metal material or an engineering plastic material with high water resistance and pressure resistance to minimize corrosion or breakage due to atmospheric conditions of the icing measurement area a.

Meanwhile, the probe 10 may be formed of a magnetostrictive material and disposed to pass through the strut 20 in the vertical direction and protrude from the installation space s so that a lower end portion of the probe 10 is inserted into the installation space s, and an upper end portion is exposed to the icing measurement area a. In this case, the magnetostrictive material may be understood as a concept that encompasses a material having a property of expanding or contracting by moving a magnetic domain in a magnetic pole direction of a magnetic field when the magnetostrictive material is exposed to an external magnetic field.

For example, the magnetostrictive material may be a ferromagnetic material and may be provided as ferrite composed of a material such as iron, nickel, cobalt, stainless steel, and an alloy thereof, and more preferably, among them, may be provided as a nickel-iron alloy composed of 40 to 42 wt % nickel, 4 to 6 wt % chromium, 2 to 3 wt % titanium, and iron at the remaining wt % with respect to the total wt % of the magnetostrictive material.

In addition, an oscillation unit may include a coil unit 40 which is disposed to surround a lower outer circumference of the probe 10 and generates a driving magnetic field for magnetostrictive oscillation, the magnet unit 50 which is disposed along an outer circumference of the coil unit 40 and generates a bias magnetic field so that an oscillation displacement of the probe 10 increases, and the elastic member 70 which is provided with a preset elasticity modulus for adjusting an oscillation frequency of the probe 10 and elastically supports the lower end portion of the probe 10.

Specifically, the coil unit 40 is installed in the installation space s and provided to surround the lower outer circumference of the probe 10 and generates a driving magnetic field for magnetostrictive oscillation. Specifically, in the coil unit 40, a wire insulated by a sheath is spirally wound a plurality of times in an axial direction of the probe 10, and when a current is applied to the coil unit 40, a spiral current flow may be formed. In addition, a driving magnetic field in which a magnetic pole is disposed along a hollow in the coil unit 40 in the axial direction of the probe 10 may be generated due to the spiral current flow.

In addition, an alternating current (AC) current in which a negative pole and a positive pole change at a preset cycle may be applied to the coil unit 40, a magnetic pole direction of the driving magnetic field may periodically reverse according to a change in a direction of a current flow. At this time, in the driving magnetic field, an N-pole and an S-pole may be disposed in the axial direction of the probe 10, and the probe 10 may be deformed to expand or contract in the magnetic pole direction of the driving magnetic field.

In addition, since the magnetic pole direction of the driving magnetic field periodically reverses, the probe 10 may magnetostrictively oscillate while repeating expansion and contraction. Specifically, a crystal grain of the magnetostrictive material has a multi-magnetic domain structure including a plurality of magnetic domains, when the crystal grain is exposed to an external magnetic field, the magnetic domains are arranged in the magnetic pole direction of the external magnetic field and combined into a single magnetic domain, and thus a size of the crystal grain increases in the magnetic pole direction. In this case, when the magnetic pole direction of the external magnetic field reverses, the combined single magnetic domain is divided, and after the size thereof in the magnetic pole direction decreases, the magnetic domains are rearranged and recombined in a direction of the changed external magnetic field, and the size of the crystal grain in the magnetic pole direction may increase again.

Meanwhile, the coil unit 40 may include a drive coil 40a and a feedback coil 40b which are vertically separately disposed in an oscillation direction of the probe 10 and wound in opposite spiral directions. In this case, the coil unit 40 may be provided to surround the lower outer circumference of the probe 10 disposed in the installation space s.

Specifically, the drive coil 40a which generates a driving magnetic field for magnetostrictive oscillation may be disposed to surround an outer circumference of one side of an interior of the installation space s. In addition, the feedback coil 40b disposed to be spaced a preset distance from the drive coil 40a may be disposed to surround an outer circumference of the other side of the interior of the installation space s. For example, the drive coil 40a may be disposed to surround a lower side of the lower outer circumference of the probe 10, and the feedback coil 40b may be disposed to surround an upper side of the lower outer circumference of the probe 10.

In addition, the drive coil 40a may be provided to be wound in the circumferential direction along the axial direction of the probe 10 and have a downward spiral form, and the feedback coil 40b may be provided to be wound in the circumferential direction along the axial direction of the probe 10 and have an upward spiral form.

Meanwhile, the variable adjustment unit 41 may be circuit-connected to the drive coil 40a and the feedback coil 40b so that a preset oscillation frequency, that is, a moving nominal resonance frequency (NRF), initially set for the probe 10 is adjusted. In this case, the preset oscillation frequency may be understood as a concept that is the same as the moving NRF and is a natural frequency generated by the magnetostrictive oscillation probe when icing does not occur on the magnetostrictive oscillation probe of the icing detection device. In addition, the preset oscillation frequency may be set to 35 to 45 kHz, and most preferably, set to 40 kHz.

Specifically, the variable adjustment unit 41 may be provided to variably adjust voltages applied to the drive coil 40a and the feedback coil 40b in order to adjust the preset oscillation frequency initially set for the probe 10. In this case, the variable adjustment unit 41 may be provided as a transistor including a base B, a collector C, and an emitter E. In this case, the transistor may also be provided as an element. In addition, the calculation control unit 32 may control a voltage applied to the base B of the transistor.

In this case, referring to FIG. 3, the drive coil 40a may be circuit-connected parallel to a variable capacitor 42, one end thereof may be circuit-connected to the collector C of the transistor, and the other end thereof may be circuit-connected to a plus terminal of the power source unit 33 including a power supply. In this case, one end of the variable capacitor 42 may be circuit-connected to the collector C of the transistor, and the other end may be circuit-connected to the plus terminal of the power source unit 33. In this case, the power source unit 33 may be provided to provide direct power.

In addition, one end of the feedback coil 40b may be circuit-connected to the base B of the transistor, and the other end thereof may be circuit-connected to a minus terminal of the power source unit 33. In addition, the calculation control unit 32 may be circuit-connected to the base B of the transistor, and the emitter E of the transistor may be circuit-connected to a first ground part g1 and grounded. In this case, the calculation control unit 32 and one end of the feedback coil 40b may be circuit-connected to a common connection node formed at the base B of the transistor.

That is, it may be understood that the freezing detection device 100 includes a common emitter amplifier circuit in which the emitter E of the transistor is grounded, the feedback coil 40b may be circuit-connected to the base B of the transistor, and the drive coil 40a may be circuit-connected to the collector C of the transistor. Accordingly, a voltage applied to the base B of the transistor may be amplified and output through the collector C of the transistor. In this case, a circuit including the variable adjustment unit 41 and the variable capacitor 42 may be disposed in the installation space s. In addition, the drive coil 40a and the feedback coil 40b may be connected to the power source unit 33 through individual incoming lines and outgoing lines, and a switching unit controlled by the calculation control unit 32 may be provided on any one of the incoming lines and the outgoing lines.

In addition, a current flow generated by the transistor may be understood as a current flowing from the collector C and the base B to the emitter E and may be expressed as Equation 1 below.

i_{E}=i_{B}+i_{C} [Equation 1]

Here, i_{E} denotes a current [A] at the emitter E, i_{B} denotes a current [A] at the base B, and i_{C} denotes a current [A] at the collector C.

In addition, an oscillation frequency generated by the drive coil 40a is calculated using Equation 2 below.

$${f}_{1} = \frac{1}{2 π \sqrt{{L}_{2} C}} \qquad [ Equation 2 ]$$

In this case, f₁ denotes an oscillation frequency [Hz] generated by the drive coil 40a, L₂ denotes an induction coefficient [H] of the drive coil 40a, and C denotes a capacitance [F] of the variable capacitor 42. That is, the oscillation frequency generated by the drive coil 40a actually has a relationship which is substantially inversely proportional to the square root of the induction coefficient of the drive coil 40a and the capacitance of the variable capacitor 42.

In addition, an oscillation frequency generated by the feedback coil 40b is calculated using Equation 3 below.

$${f}_{2} = \frac{1}{2 {L}_{1}} \sqrt{{E}_{bb} / ρ} \qquad [ Equation 3 ]$$

In this case, f₂ denotes an oscillation frequency [Hz] generated by the feedback coil 40b, L₁ denotes an induction coefficient [H] of the feedback coil 40b, E_{bb} denotes a Young's modulus which is a constant preset for the probe 10, and ρ denotes a density of the probe 10. That is, the oscillation frequency generated by the feedback coil 40b has a relationship which is substantially inversely proportional to the induction coefficient of the feedback coil 40b and proportional to the square root of the reciprocal of the density of the probe 10.

In addition, the oscillation frequency generated by the probe 10 may be set through a difference between the oscillation frequency generated by the drive coil 40a and the oscillation frequency generated by the feedback coil 40b. In this case, when voltages and currents are applied to the coil units 40a and 40b, spiral current flows e1 and e2 may be formed in opposite directions through the drive coil 40a and the feedback coil 40b along the lower outer circumference of the probe 10.

In addition, an N-pole and an S-pole may be disposed along a central portion of the spiral current flows e1 and e2 in the axial direction of the probe 10, and a pair of driving magnetic fields m1 and m2 having opposite magnetic pole directions may be formed. In this case, a lower side of the lower outer circumference of the probe 10 may expand or contract due to the driving magnetic field m1 of the drive coil 40a, and an upper side of the lower outer circumference of the probe 10 may expand or contract due to the driving magnetic field m2 of the feedback coil 40b.

Accordingly, since an upper side and a lower side of the lower outer circumference of the probe 10 may expand or contract at the same time by the pair of driving magnetic fields m1 and m2 having the opposite magnetic pole directions, the overall expansion or contraction displacement of the probe 10 may increase.

In addition, the power source unit 33 may apply AC voltages and currents with a preset cycle to the drive coil 40a and the feedback coil 40b, and the feedback coil 40b may form a part of a circuit of an oscillator 31. That is, since the incoming line or the outgoing line of the feedback coil 40b may be connected to the power source unit 33 through the oscillator 31, and the oscillator 31 may be controlled by a voltage of the feedback coil 40b, a more effective circuit can be formed.

However, in some cases, a delay circuit, which delays a cycle of the AC current to a cycle corresponding to a half value of a wavelength, may also be connected to the incoming line of the feedback coil 40b, and since magnetic fields generated by the coil units 40a and 40b are disposed in the same magnetic pole directions and mutually amplified, expansion or contraction displacement of the probe 10 can increase.

Meanwhile, the magnet unit 50 may be disposed along outer circumferences of the drive coil 40a and the feedback coil 40b to form a bias magnetic field so as to increase the oscillation displacement of the probe 10. Specifically, the magnet unit 50 may be provided as a “C”-shaped tube of which one side of an outer circumference is open to partially surround the outer circumference of the coil unit 40 and an outer circumference of the probe 10 and provided as a permanent magnet or electromagnet having an inner circumference side and an outer circumference side in which N-S poles are magnetized. That is, the magnet unit 50 may generate the bias magnetic field with a magnetic pole direction perpendicular to the magnetic pole direction of the driving magnetic field at the outside of the coil unit 40. In this case, the driving magnetic field may be pressed inward by a magnetic field of the bias magnetic field in the radial direction and may have straight magnetic force lines in the axial direction of the probe 10.

Accordingly, the magnetic pole direction of the driving magnetic field and the axial direction of the probe 10 may be aligned to increase the expansion or contraction displacement of the probe 10 and a magnitude of an amplitude during magnetostrictive oscillation, and an oscillation frequency can be accurately detected through the increased amplitude.

Meanwhile, the elastic member 70 may be disposed in the installation space s and provided with a preset elasticity modulus so that the probe 10 generates an oscillation frequency to generate magnetostrictive oscillation. In this case, the elastic member 70 may be provided as a coil spring or the like which elastically supports the lower end portion of the probe 10 and is elastically deformed in the axial direction of the probe 10. In this case, the elastic member 70 may be provided with a preset elasticity modulus to adjust the oscillation frequency of the probe 10. That is, the oscillation frequency of the probe 10 may be adjusted through the elasticity modulus of the elastic member 70.

Specifically, when the probe 10 expands or contracts in the axial direction and magnetostrictively oscillates due to a driving magnetic field, the oscillation of the probe 10 is transmitted to the elastic member 70. In this case, the elastic member 70 may oscillate with a natural oscillation frequency according to the elasticity modulus thereof, and the oscillation frequency of the probe 10 may increase or decrease through cancelation or amplification.

Accordingly, an oscillation frequency due to the magnetostrictive oscillation can be easily adjusted by only selecting the elasticity modulus of the elastic member 70 and arranging the elastic member 70 to elastically support the lower end portion of the probe 10 without complicatedly changing a design by adjusting a magnitude or cycle of the driving magnetic field using the number of windings, a length, and a thickness of the coil unit 40, a frequency, an amplitude, and the like of AC current or changing a cross-sectional area, a length, a weight of the probe 10. That is, even in a state in which the magnitude or cycle of the driving magnetic field and a standard of the probe 10 are not changed, since a magnetostrictive oscillation frequency may be adjusted within a wide range such as from 40 kHz to 40 Hz, an initial oscillation frequency suitable for various atmospheric conditions of the icing measurement area a may be easily set, product compatibility can be improved.

Meanwhile, the calculation control unit 32 may be circuit-connected to the variable adjustment unit 41 and provided to receive a voltage and a current corresponding to an oscillation frequency. In addition, the calculation control unit 32 may be provided to indirectly determine an iced state of the icing detection target 1 through a change in oscillation frequency of the probe 10 due to an ice load.

In this case, in a state in which the probe 10 magnetostrictively oscillates with a constant initial oscillation frequency, when icing occurs on an upper outer circumference of the probe 10, an oscillation frequency of the probe 10 is lowered due to a weight of ice, and as the ice grows, an extent of a decrease in the oscillation frequency of the probe 10 also increases. In this case, the calculation control unit 32 may determine an iced state of the probe 10 by comparing an oscillation frequency of the probe 10 in an initial state (thawed state) and an oscillation frequency of the probe 10 in the iced state.

That is, when icing occurs on the icing detection target 1 due to the atmospheric conditions of the target area k, icing occurs on the probe 10 exposed to the icing measurement area a in the atmospheric conditions similar to the atmospheric conditions of the target area k. Accordingly, the iced state of the icing detection target 1 may be indirectly detected through the iced state of the probe 10.

As described above, unlike the convention case in which a sensor device for icing detection is directly installed on an icing detection target 1, whether icing occurs and a growth state thereof according to the atmospheric conditions of the target area k can be indirectly detected through a change in oscillation frequency of the probe 10 disposed in the icing measurement area a close to the target area k.

Accordingly, since an influence of the rotation of an aircraft engine and the like can be minimized, performance degradation of the icing detection target 1 can be prevented, and since whether the icing occurs and the growth state thereof of the icing detection target 1 can be stably monitored in the icing measurement area in which there is no direct motion such as rotation, the installation convenience and durability of a product can be improved.

Meanwhile, the calculation control unit 32 may further include the oscillator 31 which detects an oscillation frequency of the probe 10 in real time. In addition, when the oscillation frequency detected by the oscillator 31 decreases to be lower than or equal to a preset icing reference frequency, the calculation control unit 32 may transmit a monitoring signal corresponding to an iced state. In this case, the calculation control unit 32 may be provided as a microcontroller and the like and may perform a series of processes of comparing the oscillation frequency detected through the oscillator 31 with the preset icing reference frequency.

In this case, a correlation between a change in the oscillation frequency of the probe 10 and an extent of icing (a growth state of ice) of the probe 10 may be derived experimentally, and a database for the derived correlation may be stored in a storage unit 34 in a table form.

In this case, the icing reference frequency may be set on the basis of the correlation in advance. For example, the icing reference frequency may be set to an oscillation frequency at a time point at which icing of the probe 10 starts from the database for the derived correlation and may also be set to an oscillation frequency at a time point at which generated ice grows to an extent causing performance degradation of the icing detection target 1.

In addition, when the oscillation frequency detected through the oscillator 31 decreases to be lower than or equal to the icing reference frequency, the calculation control unit 32 may transmit a monitoring signal corresponding to the icing occurrence to the management server (not shown).

However, the icing reference frequency may be set in multiple steps according to a growth rate of ice, and when the oscillation frequency decreases to an icing reference frequency corresponding to one of the multiple steps, the calculation control unit 32 may transmit a monitoring signal which indicates the growth rate of ice for each step to the management server.

In this case, the management server (not shown) generates a notification message for whether icing occurs on the icing detection target 1 and a growth state thereof according to the received monitoring signal and displays the notification message on the manager side display (not shown). Accordingly, a series of maintenance work of removing the ice generated on the icing detection target 1 may be performed. Accordingly, degradation of durability and performance of the icing detection target 1 due to the icing may be minimized.

Meanwhile, a digital-analog converter 81 and an analog-digital converter 82 may be disposed to be circuit-connected in parallel between the calculation control unit 32 and the base B of the transistor in order to convert signals transmitted and received therebetween. In addition, an operational amplifier 83 may be disposed to be circuit-connected between the calculation control unit 32 and the base B of the transistor to amplify the signals transmitted and received therebetween.

Specifically, an input terminal of the digital-analog converter 81 and an output terminal of the analog-digital converter 82 may be circuit-connected to the calculation control unit 32 in parallel. In addition, an output terminal of the digital-analog converter 81 and an input terminal of the analog-digital converter 82 may be circuit-connected to a plus input terminal of the operational amplifier 83. In addition, a minus input terminal of the operational amplifier 83 may be circuit-connected to an output terminal of the operational amplifier 83, and an output terminal of the operational amplifier 83 may be circuit-connected to the common connection node formed at the base B of the transistor.

In addition, referring to FIG. 3, an AC power supply unit VCC and a second ground part g2 may be disposed to be circuit-connected in parallel between the output terminal of the operational amplifier 83 and the common connection node, which is connected to the base B of the transistor.

In addition, a first resistance element R1 may be disposed to be circuit-connected between the AC power supply unit VCC and the common connection node, and a second resistance element R2 may be disposed to be circuit-connected between the common connection node and the second ground part g2.

Accordingly, signals transmitted and received between the calculation control unit 32 and the variable adjustment unit 41 and the coil unit 40 may be converted, amplified, transmitted, and received as digital and analog signals.

Meanwhile, the freezing detection device 100 may further include a PC unit 80 communicatively-connected to the calculation control unit 32 to adjust a preset oscillation frequency initially set for the probe 10. In this case, the PC unit 80 may be connected to the calculation control unit 32 through an RS-485 serial communication method or the like. In addition, the PC unit 80 may be separately provided in a cockpit of the aircraft and the like unlike the probe 10 and the strut 20 installed in the icing measurement area a.

In this case, when an oscillation frequency measured through the oscillator 31 is higher than or equal to the preset oscillation frequency, the PC unit 80 may control a voltage applied to the base B of the transistor to increase as much as a preset value. In addition, when the oscillation frequency measured through the oscillator 31 is lower than the preset oscillation frequency, the PC unit 80 may control the voltage applied to the base B of the transistor to decrease as much as the preset value.

Specifically, referring to FIG. 5, first, an oscillation frequency generated by the probe 10 is measured through the oscillator 31 in real time (s10). In addition, the calculation control unit 32 and the PC unit 80 are connected to each other through RS-485 serial communication (s11 and s12).

In addition, the PC unit 80 compares and determines the oscillation frequency measured through the oscillator 31 and the preset oscillation frequency (s13). In this case, the preset oscillation frequency may be understood as a concept that is the same as a moving NRF and is a natural frequency generated by the probe when icing does not occur on the magnetostrictive oscillation probe of the icing detection device. In addition, the preset oscillation frequency may be set to 35 to 45 kHz, and most preferably, may be set to 40 kHz.

In this case, when the oscillation frequency measured through the oscillator 31 is higher than or equal to the preset oscillation frequency, the PC unit 80 controls the voltage applied to the base B of the transistor to increase as much as a preset value (s14). In this case, when a signal generated by the PC unit 80 is transmitted to the calculation control unit 32, the calculation control unit 32 may control the voltage applied to the base B of the transistor to increase.

In addition, when the oscillation frequency measured through the oscillator 31 is the same as the preset oscillation frequency, the PC unit 80 may allow a process in which the calculation control unit 32 controls the voltage applied to the base B of the transistor to be omitted.

On the other hand, the oscillation frequency measured through the oscillator 31 is lower than the preset oscillation frequency, the PC unit 80 controls the voltage applied to the base B of the transistor to decrease as much as a preset value (s15). In this case, when a signal generated by the PC unit 80 is transmitted to the calculation control unit 32, the calculation control unit 32 may control the voltage applied to the base B of the transistor to decrease.

In addition, the calculation control unit 32 compares and determines whether the oscillation frequency measured through the oscillator 31 is within a preset oscillation frequency range (s16). In this case, when the oscillation frequency of the oscillator 31 is within the preset oscillation frequency range, the calculation control unit 32 stores data for a value of the voltage applied to the base B of the transistor in the storage unit 34 and stops an algorithm (s17).

On the other hand, when the oscillation frequency measured through the oscillator 31 is outside the preset oscillation frequency range, the calculation control unit 32 resets the value of the voltage applied to the base B of the transistor (s18). Then, the above-described algorithm may be iteratively performed.

In this case, as the voltage applied to the base B of the transistor is increased by the calculation control unit 32, the oscillation frequency generated by the probe 10 decreases, and as the voltage applied to the base B of the transistor is decreased, the oscillation frequency generated by the probe 10 increases. For example, when the voltage applied to the base B of the transistor is 2.8 V, the oscillation frequency may be set to 39.5 to 39.9 kHz, and when the voltage is 2.6 V, the oscillation frequency may be set to 40.1 to 40.5 kHz. In this case, it may be understood that the value of the oscillation frequency is exemplary, and the value is not limited thereto.

In addition, the calculation control unit 32 may set sensitivity for an oscillation frequency generated by the probe 10. In this case, the sensitivity is calculated as a ratio of a decrease in a response frequency to a thickness of ice generated on a surface of the probe 10. In addition, the sensitivity may be set to 250 to 270 Hz/mm, and most preferably, set to 260 Hz/mm. For example, when a decrease in a response frequency of the probe is 130 Hz at a time point at which a thickness of ice generated on the probe 10 is 0.5 mm, the sensitivity may be set to 130 Hz/0.5 mm=260 Hz/mm.

As described above, the variable adjustment unit 41 provided as a transistor is circuit-connected to the drive coil 40a and the feedback coil 40b and controls the voltage applied to the base B of the transistor to increase/decrease through the calculation control unit 32.

Accordingly, unlike the conventional case in which a moving NRF is adjusted through a physical task of winding amount and interval changes between coils and replacement of a magnet unit, a moving NRF may be easily adjusted by controlling a voltage applied to the variable adjustment unit 41 circuit-connected to the drive coil 40a and the feedback coil 40b through the calculation control unit 32 communicatively-connected to the PC unit 80.

Accordingly, unlike the conventional case in which the winding amount and interval changes between the coils and the replacement of the magnet unit are required when the moving NRF generated by the probe 10 is different from a preset value, since the moving NRF is easily adjusted, work convenience can be significantly improved.

In addition, the preset oscillation frequency initially set for the probe 10, that is, the moving NRF, is quickly accurately and remotely adjusted by controlling the voltage applied to the base B of the transistor to increase/decrease through the PC unit 80 communicatively-connected to the calculation control unit 32. Accordingly, during operation, when an abnormality occurs in the freezing detection device 100, emergency measures are possible.

Accordingly, the variable adjustment unit 41 is provided as a transistor to variably adjust a voltage applied to the feedback coil 40b, the voltage applied to the base B of the transistor is remotely controlled through the PC unit 80 installed in the cockpit of the aircraft and the calculation control unit 32. Accordingly, since the moving NRF initially set for the probe 10 is quickly and accurately adjusted, operational safety can be significantly improved.

In addition, since the PC unit 80 automatically controls the voltage applied to the base B of the transistor, the moving NRF is automatically controlled within the preset oscillation frequency range. Accordingly, reliability of the sensitivity calculated as the ratio of the decrease in the response frequency to the thickness of the ice generated on the surface of the probe 10 can be significantly improved.

Furthermore, since the freezing detection device 100 may be precisely set only by simply adjusting the voltage applied to the base B of the transistor even without detailed knowledge about an icing detection principle, use convenience can be significantly improved. That is, when a moving NRF generated by the probe 10 is different from the preset value, the moving NRF can be accurately adjusted by only simply adjusting the voltage applied to the base B of the transistor even without physical work such as winding amount and interval changes between the coils and replacement of the magnet unit.

Meanwhile, a heating unit 60a which heats the probe 10 according to a monitoring signal transmitted to initialize an oscillation frequency of the probe 10 by removing ice generated in advance may be provided in the installation space s.

In this case, the heating unit 60a may include a heating member formed of a nickel alloy, a lower end portion of the heating unit 60a may be connected to the power source unit 33, and the power source unit 33 may control power supply for the heating unit 60a according to a monitoring signal of the calculation control unit 32.

In this case, a heating tube part 61 disposed to surround the outer circumference of the probe 10 may be provided at an upper end portion of the heating unit 60a. Specifically, the heating tube part 61 may be formed in a ring or arc shape having an inner diameter greater than an outer diameter of the probe 10 and disposed between a lower edge of the probe through hole 21 and an upper edge of the coil unit 40.

In addition, an inner circumferential part of the heating tube part 61 may be disposed to surround an entirety or majority of the outer circumference of the probe 10 in a state in which the inner circumferential part of the heating tube part 61 is spaced a preset distance from the outer circumference of the probe 10.

In addition, heat of the heating tube part 61 may be transferred to the probe 10 through radiation, and the probe 10 may be heated to remove ice generated on the surface thereof without being in direct contact with the heating unit 60a. Accordingly, since distortion of an oscillation frequency of the probe 10 may be prevented, detection accuracy for an iced state can be improved.

In this case, the heating unit 60a may be controlled to stop after being driven according to a preset heating stand-by time, and when a temperature sensor (not shown) which detects a temperature of the probe 10 is provided, the probe 10 may be controlled to stop when a temperature of the probe 10 rises to a preset temperature. In the present embodiment, an example in which the heating unit 60a stops due to an oscillation frequency of the probe 10 will be described.

In this case, the heating unit 60a may be controlled to stop driving when an oscillation frequency of the probe 10 rises above a preset normal state frequency. In this case, it may be understood that the normal state frequency is an initial oscillation frequency of the probe 10, and more preferably, the normal state frequency may be set to a value decreased by a predetermined deviation from the initial oscillation frequency in consideration of a decrease in the oscillation frequency due to moisture generated during ice removal.

In this case, the calculation control unit 32 may compare an oscillation frequency detected through the oscillator 31 with the normal state frequency, and when the oscillation frequency rises above the normal state frequency, the calculation control unit 32 may transmit a monitoring signal corresponding to the normal state. In this case, the power source unit 33 may stop power supply for the heating unit 60a according to the monitoring signal corresponding to the normal state.

Accordingly, as the heating unit 60a can be precisely controlled to completely remove the ice on the probe 10 even without a separate control unit such as a temperature sensor and a timer, production productivity can be improved due to a simplified structure, and the probe 10 can also be stably initialized. Accordingly, detection accuracy for an iced state can be improved.

Meanwhile, an auxiliary heating unit 60b may be provided on an inner wall surface of the strut 20. In this case, the auxiliary heating unit 60b may be provided as a heating wire formed of a nickel alloy like the heating unit 60a and may be buried in the inner wall surface of the strut 20.

In this case, the auxiliary heating unit 60b may be arranged to form a ring- or arc-shaped wall corresponding to the inner wall surface of the strut 20, and a lower end portion of the auxiliary heating unit 60b may be connected to the power source unit 33 and controlled along with the heating unit 60a at the same time.

That is, when icing occurs on the probe 10, a monitoring signal corresponding to an iced state is transmitted through the calculation control unit 32, and the power source unit 33 may supply power to the auxiliary heating unit 60b and the heating unit 60a according to the transmitted monitoring signal. In this case, when the auxiliary heating unit 60b is heated, the auxiliary heating unit 60b may transfer the heat to the strut 20 through conduction.

In addition, since the strut 20 is heated, ice generated on a surface of the strut 20 may be removed. At the same time, the heat of the strut 20 may raise a temperature of the icing measurement area a at an upper surface side of the strut 20 to quickly remove ice on the probe 10.

Meanwhile, although not illustrated in the drawings, the freezing detection device 100 according to one embodiment of the present invention may also further include an airflow acceleration frame (not shown) extending to protrude upward from the strut 20 so as to improve a response speed of the probe 10 by allowing an airflow, which moves along an outer edge of the probe 10, to quickly pass.

In this case, the airflow acceleration frame (not shown) may be provided to facilitate a decrease in temperature of the icing measurement area a due to the airflow which moves along the outer edge of the probe 10.

Specifically, the airflow acceleration frame (not shown) according to one embodiment of the present invention may be provided as a plate member having a square or rectangular cross section. In addition, the airflow acceleration frame (not shown) may be disposed perpendicular to the upper surface of the strut 20 in a central portion of the strut 20 in a width direction thereof.

In addition, the airflow acceleration frame (not shown) may be disposed parallel to a main flow direction of the airflow, and most preferably, disposed in the front-rear direction of the strut 20.

In addition, a width of the airflow acceleration frame (not shown) may be smaller than or equal to a diameter of the probe 10, and an end portion of two end portions in a longitudinal direction of the airflow acceleration frame (not shown) adjacent to the probe 10 may be disposed to be spaced a preset distance from the probe 10.

In this case, the airflow acceleration frame (not shown) according to one embodiment of the present invention may be disposed at a rear end portion of the outer circumference of the probe 10 to prevent the generation of an eddy flow and a turbulent flow at the rear end portion of the probe 10. In this case, it may be understood that a front end portion of the airflow acceleration frame (not shown) according to one embodiment of the present invention is disposed to be spaced a preset distance from an outer surface of the probe 10.

Specifically, a separation distance between an end portion of the airflow acceleration frame (not shown) and the outer surface of the probe 10 may be in the range of 0.6 to 1.0 mm. In this case, when the separation distance between the end portion of the airflow acceleration frame (not shown) and the outer surface of the probe 10 is less than 0 6 mm, there is a possibility that icing occurs between the end portion of the airflow acceleration frame (not shown) and the outer surface of the probe 10, vertical oscillation of the probe 10 for icing detection is stopped, and thus whether icing occurs is not determined.

In this case, when icing occurs on the outer surface of the probe 10, and a thickness of the ice is greater than or equal to 0.5 mm as ice grows outward in a radial direction, it may be determined that icing occurs by the calculation control unit 32. That is, when the separation distance between the end portion of the airflow acceleration frame (not shown) and the outer surface of the probe 10 is less than 0.6 mm, there is the possibility that the calculation control unit 32 may not determine occurrence of icing.

On the other hand, when the separation distance between the end portion of the airflow acceleration frame (not shown) and the outer surface of the probe 10 is greater than 1.0 mm, there is a possibility that an airflow becomes turbulent, air molecules collide to increase a temperature, and detection accuracy may be lowered when icing is detected. That is, there is a possibility that a slight difference between an actual temperature of the target area k and an actual temperature of the icing measurement area a occurs, and detection accuracy is lowered.

Accordingly, since the separation distance between the end portion of the airflow acceleration frame (not shown) and the outer surface of the probe 10 is in the range of 0.6 to 1.0 mm, the airflow is prevented from becoming turbulent, and thus an increase in a temperature of the icing measurement area is prevented. In addition, since airflow acceleration frames (not shown) are disposed with an optimum interval distance at which icing may occur on the surface of the probe 10 for icing detection, detection accuracy can be significantly improved when icing is detected through the probe 10.

Furthermore, an end portion of two end portions in the longitudinal direction of the airflow acceleration frame (not shown) adjacent to the probe 10 may be formed in a concavely curved shape corresponding to the outer circumference of the probe 10.

In addition, a height of the airflow acceleration frame (not shown) may be lower than or equal to a height of an upper end portion of the probe 10, and a maximum height of a front end side of the airflow acceleration frame (not shown) may be 80 to 100% of the height of the upper end portion of the probe.

In this case, when the maximum height of the front end side of the airflow acceleration frame (not shown) is less than 80% of the height of the upper end portion of the probe or greater than 100% thereof, there is a possibility that detection accuracy is lowered or air resistance suddenly increases according to an increase in a temperature due to a turbulent airflow. Accordingly, since the maximum height of the front end side of the airflow acceleration frame (not shown) is 80 to 100% of the height of the upper end portion of the probe, which is an optimized height derived experimentally, detection accuracy of the probe 10 can be improved.

In addition, the airflow acceleration frame (not shown) may be formed of a metal material or engineering plastic material with high water and pressure resistance so as to minimize corrosion or damage due to the atmospheric conditions of the icing measurement area a.

In this case, when an airflow acceleration frame (not shown) is not provided like the conventional case, as an airflow, which moves from a front side to a rear side of the strut 20, moves along an outer edge of the probe 10, an eddy flow and a turbulent flow are generated at the rear side of the probe 10.

Accordingly, as the airflow moving along the outer edge of the probe 10 is decelerated, an air pressure of the icing measurement area a increases, collisions between air molecules increase, and thus a temperature of the icing measurement area a is raised. In this case, a correlation between a pressure and a temperature according to the turbulent flow and the decelerated airflow may be experimentally derived, and it is generally known that a speed and a pressure of an airflow have an inverse relationship and a pressure and a temperature have a proportional relationship.

Furthermore, in the conventional icing detection device, in an actual temperature region of −0.6 to −0.8° C., there was a case in which an actual temperature of an icing measurement area a is relatively greater than an actual temperature of a target area k due to a turbulent airflow generated due to a probe 10. In this case, in the freezing detection device 100 according to the present invention, as the airflow acceleration frame (not shown) extends to protrude upward from the strut 20, an airflow, which moves along the outer edge of the probe 10 may be generated as a substantially laminar flow.

Accordingly, the airflow of the icing measurement area a is changed to a form substantially similar to the laminar flow of the target area k, in which the icing detection target 1 is disposed, due to the airflow acceleration frame (not shown). Accordingly, since the probe 10 which indirectly detects whether icing occurs and a growth state thereof is exposed to atmospheric conditions similar to atmospheric conditions of the icing detection target 1, detection accuracy for whether the icing occurs and the growth state thereof can be significantly improved.

Furthermore, some cases, when an actual temperature of the icing measurement area a is lower than an actual temperature of the target area k due to the airflow acceleration frame (not shown), since icing may occur on the probe 10 before icing occurs on the icing detection target 1, whether icing occurs may also be checked through the freezing detection device 100 in advance.

Accordingly, since whether icing occurs is quickly checked before icing occurs on the icing detection target 1 such as an aircraft by the airflow acceleration frame (not shown) which extends to protrude upward from the strut 20 installed in the icing measurement area a and is disposed in the central portion of the strut 20 in the width direction to be parallel to a direction in which an airflow mainly moves, safety can be significantly improved during operation.

As described above, the present invention is not limited to the above-described embodiments, and may be variously modified by those skilled in the art without departing from the scope of the present invention, and such modifications fall within the scope of the present invention.

### INDUSTRIAL APPLICABILITY

The present invention may be applied to industry for manufacturing and using mechanical apparatuses which are used outside by providing A freezing detection device with improved accuracy of detecting the occurrence of icing on an outer surface of the mechanical apparatus such as an aircraft or wind power generator.

1. A freezing detection device comprising:
a strut installed in an icing measurement area in which an icing detection target is disposed and having an installation space formed therein;
a probe which is formed of a magnetostrictive material and disposed to pass through the strut and has a lower end portion inserted into the installation space and an upper end portion exposed to the icing measurement area and in which a drive coil configured to generate a driving magnetic field for magnetostrictive oscillation is disposed to surround an outer circumference of one side of an interior of the installation space and a feedback coil disposed to be spaced a preset distance from the drive coil is disposed to surround an outer circumference of the other side of the interior of the installation space;
a variable adjustment unit circuit-connected to the drive coil and the feedback coil to adjust a preset oscillation frequency initially set for the probe;
a magnet unit disposed along an outer circumference of the drive coil and an outer circumference of the feedback coil to generate a bias magnetic field so as to increase an oscillation displacement of the probe;
an elastic member which is disposed in the installation space and provided with a preset elasticity modulus to allow the probe to generate an oscillation frequency and which generates magnetostrictive oscillations and elastically supports the probe; and
a calculation control unit which is circuit-connected to the variable adjustment unit and applies a voltage corresponding to the oscillation frequency to the variable adjustment unit and which indirectly determines an iced state of the icing detection target through a change in the oscillation frequency of the probe due to an ice load.

2. The freezing detection device of claim 1, wherein:
the variable adjustment unit is provided as a transistor;
the calculation control unit controls a voltage applied to a base of the transistor;
one end of the drive coil is circuit-connected to a collector of the transistor;
the other end of the drive coil is circuit-connected to a plus terminal of a power source unit provided for varying supply power and is circuit-connected to a variable capacitor in parallel;
one end of the feedback coil is circuit-connected to the base of the transistor;
the other end of the feedback coil is circuit-connected to a minus terminal of the power source unit;
the calculation control unit is circuit-connected to the base of the transistor; and
an emitter of the transistor is grounded.

3. The freezing detection device of claim 2, further comprising:
a PC unit communicatively-connected to the calculation control unit to remotely adjust the preset oscillation frequency initially set for the probe; and
an oscillator provided to detect the oscillation frequency in real time and circuit-connected to the calculation control unit,
wherein the PC unit controls a voltage applied to the base of the transistor to increase as much as a preset value when the oscillation frequency measured through the oscillator is higher than or equal to the preset oscillation frequency and controls the voltage applied to the base of the transistor to decrease as much as the preset value when the oscillation frequency measured through the oscillator is lower than the preset oscillation frequency.

4. The freezing detection device of claim 2, wherein:
the calculation control unit sets sensitivity for the oscillation frequency generated by the probe;
the sensitivity is calculated as a ratio of a decrease in a response frequency to a thickness of ice generated on a surface of the probe; and
a digital-analog converter and an analog-digital converter are disposed to be circuit-connected in parallel between the calculation control unit and the base of the transistor to convert signals transmitted and received between the calculation control unit and the base of the transistor.

5. The freezing detection device of claim 1, wherein:
the calculation control unit transmits a monitoring signal corresponding to an iced state when the oscillation frequency detected by the oscillator which detects the oscillation frequency of the probe in real time decreases to be lower than or equal to a preset icing reference frequency; and
the freezing detection device further comprises a heating unit which heats the probe according to the monitoring signal transmitted to initialize the oscillation frequency of the probe.
